(19) United States
(12) Patent Application Publication
(10) Pub. No.: US 2010/0002107 A1
(43) Pub. Date: Jan. 7, 2010

(54) SOLID-STATE IMAGE PICKUP APPARATUS AND MANUFACTURING METHOD THEREOF

(76) Inventor: Fumikazu Harazono, Kanagawa (JP)

Correspondence Address: MCDERMOTT WILL & EMERY LLP, 600 13TH STREET, NW, WASHINGTON, DC, 20005-3096, US

(21) Appl. No.: 12/374,971

(22) PCT Filed: Dec. 13, 2007
(86) PCT No.: PCT/JP2007/074037

§ 371 Date: Jan. 23, 2009

(30) Foreign Application Priority Data
Dec. 13, 2006 (JP) 2006-335946

(51) Int. Cl. H04N 5/335; B32B 37/02

(52) U.S. Cl. 348/294; 156/242

(57) ABSTRACT

A solid-state image pickup apparatus and a manufacturing method thereof are provided to prevent a burr from dropping off onto a light reception face that causes a black point deterioration of a video image and to improve in productivity. The solid-state image pickup apparatus according to the invention is a solid-state image pickup apparatus including a flat board for placing a solid-state image pickup device and a lens, wherein the flat board has a through opening and has a wiring section for placing the solid-state image pickup device on the opening face that a light reception face of the solid-state image pickup device faces and a step part for placing the lens in the opening end part on the opening face side of the through opening, and the solid-state image pickup device placed on the wiring section and the lens placed in the step part are integrally sealed with a resin.

### TECHNICAL FIELD

This invention relates to a solid-state image pickup apparatus and a manufacturing method thereof, and in particular to a small solid-state image pickup apparatus formed to employ a solid-state image pickup device, such as a surveillance camera, a medical camera, a vehicle-installed camera, or an information communication terminal camera, and a manufacturing method of the solid-state image pickup apparatus.

### BACKGROUND ART

In recent years, with the progression of miniaturization and higher performance of a solid-state image pickup apparatus employing a solid-state image pickup device, a camera has also been miniaturized and the solid-state image pickup apparatus has been used in various quarters and has widened a market as a video input unit.

Components such as a lens, a solid-state image pickup device, and an LSI having a drive circuit, a signal processing circuit, etc., are formed in a cabinet or a board structure, etc., and these are combined to form a solid-state image pickup apparatus.

For example, a solid-state image pickup apparatus with elements installed on a printed board made of glass fiber, epoxy resin, etc., is available.

FIG. 4A is an external perspective view of a solid-state image pickup apparatus using a flat printed board in a related art. FIG. 4B is a sectional view taken on line A-A in FIG. 4A. As shown in FIGS. 4A and 4B, a printed board 101 having components which configures a solid-state image pickup apparatus 100 is formed at the center with a through opening 101a.

The printed board 101 is formed with a printed wiring pattern 110 on one side of the flat faces (hereinafter, a back side). A step part 101b is provided in an inner wall of the opening end part opened to an opposite face where the printed wiring pattern 110 is not formed (hereinafter, a front side), of opening end parts of the through opening 101a, and a lens 102 is fitted onto the step part. The printed board 101 has a solid-state image pickup device 103 placed on the opening face on the back side where the printed wiring pattern 110 is formed. A diaphragm member 104 for adjusting the amount of light entering the lens 102 is fitted onto the through opening 101a so as to overlap the lens.

The solid-state image pickup device 103 is connected to the printed wiring pattern 110 provided on the back side of the printed board 101 through a bump 103a formed on the surface and is sealed with a sealing resin 107, whereby it is fixed to the printed board 101.

The printed wiring pattern 110 of the printed board 101 is electrically connected to a drive circuit, a signal processing circuit, etc.

FIGS. 5 and 6 are assembly process drawings of the solid-state image pickup apparatus in the related art. In implementation, first a printed board 101 formed with a printed wiring pattern 110 is molded (FIG. 5A).

A solid-state image pickup device 103 is placed at a position where the printed wiring pattern 110 comes in contact with a bump 103a and where the solid-state image pickup device 103 covers a through opening 101a on the printed wiring pattern 110 (FIG. 5B).

After this, a sealing resin 107 is injected into a gap between the solid-state image pickup device 103 and the printed board 101 while irradiating with light (FIG. 5C). At this time, the sealing resin 107 hardens in the range in which the irradiated light reaches the resin. Numeral 107a in FIG. 5C denotes a sealing resin harden part hardened by irradiation with light. Further, after this, the remaining portion of the sealing resin 107 is thermally hardened and the placing step of the solid-state image pickup device 103 is complete (FIG. 5C).

Next, in order to mount a lens 102, the printed board 101 is inverted (FIG. 6A). An outer peripheral edge 102a of the lens 102 is placed on a step part 101b of the printed board 101 and the lens 102 is fitted into the through opening 101a (FIG. 6B). Then, a doughnut-shaped diaphragm member 104 is further fitted on the lens (FIG. 6C). After the diaphragm member 104 is fitted, an adhesive is applied to the vicinity of the boundary between the diaphragm member 104 and the printed board 101 and is hardened, to complete the assembling process of the solid-state image pickup apparatus 100.

As stated above, the solid-state image pickup apparatus provided with components such as the lens, the solid-state image pickup device, and the LSI containing the drive circuit, the signal processing circuit, etc., installed on the flat printed board formed of an insulator of glass fiber, epoxy resin, etc., is proposed in the related art.

To miniaturize the apparatus, for example, another solid-state image pickup apparatus provided with elements installed on a stereoscopic printed board made of resin is also proposed (refer to Patent Document 1). Patent document 1: Japanese Patent Publication No. 2001-245186

### DISCLOSURE OF THE INVENTION

### Problems to be Solved by the Invention

However, the flat printed board 101 in the related art is made of glass fiber, epoxy resin, etc., and thus a foreign material of dust, a burr, etc., easily occurs in the end part of the through opening 101a, an inner wall 101c, etc. Further, in the solid-state image pickup apparatus as described above, the through opening 101a of the printed board 101 is filled as it is sandwiched between the lens 102 and the solid-state image pickup device 103 from the back and front face and thus the end part of the through opening 101a and the inner wall 101c are exposed to a light reception face 103b of the solid-state image pickup device 103 still after the respective members are placed.

Therefore, after completion of the assembling process of the respective members of the solid-state image pickup apparatus, an subsequent shock (for example, shock at the transporting, shock at falling, etc.) may cause a foreign material of dust, a burr, etc., occurring in the end part of the through opening 101 a or the inner wall 101c to drop off onto the light reception face 103b of the solid-state image pickup device 103, causing a black point deterioration of a video image.

For the solid-state image pickup apparatus using a stereoscopic printed board as described in Patent Document 1, the stereoscopic printed board is formed by molding polyphthalamide resin having structure insulation properties or the like with a mold. Thus, a burr easily occurs in the end part of the through opening c, the inner wall, etc., and likewise may cause a black point deterioration of the vide image to occur.

In the solid-state image pickup apparatus described above, the solid-state image pickup device and the lens are placed on the opposite opening end parts regardless of use of the flat or stereoscopic printed board. Thus, in the manufacturing process, after the step of placing one of the solid-state image pickup device and the lens terminates, a step of turning the board upside down is necessary before the other is placed; the manufacturing process is long and the productivity is low.

The invention is embodied in considering the circumstances described above, and it is an object of the invention to provide a solid-state image pickup apparatus for preventing a burr from dropping off onto the light reception face that causes a black point deterioration of a video image and improving productivity and a manufacturing method of the solid-state image pickup apparatus.

### Means For Solving the Problems

A solid-state image pickup apparatus of the invention includes a flat board having a through opening, a step part provided in an opening end part of the through opening, and a wiring section provided on the same face as the step part; a translucent member placed on the step part; a solid-state image pickup device placed on the wiring section so that a light reception face of the solid-state image pickup device faces the translucent member; and a sealing part which seals with a resin the placing area of the translucent member placed on the step part and the solid-state image pickup device, integrally.

That is, the solid-state image pickup apparatus is a solid-state image pickup apparatus including the flat board for placing the solid-state image pickup device and the lens, wherein the flat board has the through opening and has the wiring section for placing the solid-state image pickup device on the opening face that the light reception face of the solid-state image pickup device faces, and the step part for placing the lens in the opening end part on the opening face side of the through opening, and the solid-state image pickup device placed on the wiring section and the lens placed on the step part are integrally sealed by a resin.

According to this configuration, the solid-state image pickup device and the lens are placed on one side of the flat board (the side where the wiring section is formed) and are integrally sealed by a resin unlike the mode in which a solid-state image pickup device and a translucent member such as a lens are placed so as to sandwich a board as in the related art, so that the inner wall of the through opening and the end part of the through opening on the light reception face side are covered with the outer peripheral edge of the lens and the sealing resin and are not exposed to the light reception face of the solid-state image pickup device. Thus, a foreign material of a burr, powder dust, etc., causing a black point deterioration of video image can be prevented from dropping off onto the light reception face.

The solid-state image pickup apparatus of the invention contains a solid-state image pickup apparatus wherein the through opening of the flat board includes a diaphragm part which is disposed in an end part on a second face, opposite to a first face that the light reception face of the solid-state image pickup device faces, and adjusts an amount of light entering the light reception face.

In the solid-state image pickup apparatus of the invention, the through opening of the flat board is formed with the diaphragm part for adjusting the amount of light entering the light reception face in the end part on the opposite side to the opening face that the light reception face of the solid-state image pickup device faces.

According to this configuration, an additional diaphragm member need not to be provided and the number of components can be decreased. And in addition, the diaphragm part is formed in the structure molding step of forming the flat board, and thus, the later step of placing the diaphragm member can be omitted.

The solid-state image pickup apparatus of the invention contains a solid-state image pickup apparatus wherein the diaphragm part is formed integrally with the flat board.

The solid-state image pickup apparatus of the invention contains a solid-state image pickup apparatus wherein the diaphragm part is formed as a member separate from the flat board.

Thus, the diaphragm part may be formed integrally with the flat board or may be formed as a separate member. To form the diaphragm part as a separate member, when the amount of light entering the light reception face of the solid-state image pickup device is changed, the design of the whole flat board need not to be changed and the shape of the diaphragm member needs only to be changed.

The translucent member of the solid-state image pickup apparatus of the invention may have an infrared cutting function or an antireflection function.

According to this configuration, an optical filter having the infrared cutting function, the antireflection function, etc., can be omitted and the number of components can be decreased.

A manufacturing method of a solid-state image pickup apparatus of the invention includes a flat board molding step of molding a flat wiring board having a through opening, a step part provided in an opening end part of the through opening, and a wiring section provided on the same face as the step part; a translucent member placing step of placing the translucent member on the step part; a solid-state image pickup device placing step of placing the solid-state image pickup device on the wiring section; and a resin sealing step of sealing with a resin the solid-state image pickup device placed on the wiring section and the placing area of the translucent member placed on the step part, integrally.

According to the steps, the translucent member such as a lens and the solid-state image pickup device are placed on the same face of the flat board, so that the respective members can be placed on the flat board in sequence without the need for turning the printed board 11 upside down (back and front). That is, the inverting or turning step can be omitted. The step of adhering the respective members is executed only once by resin sealing and productivity improves as compared with the manufacturing method in the related art.

The solid-state image pickup apparatus of the invention contains a solid-state image pickup apparatus wherein the step of molding the flat board is a step of molding the flat board so that the through opening includes a diaphragm part which is disposed in an end part on a second face, opposite to a first face that the light reception face of the solid-state image pickup device faces, and adjusts an amount of light entering the light reception face.

The solid-state image pickup apparatus of the invention contains a solid-state image pickup apparatus wherein the step of molding the flat board includes a step of molding the diaphragm integrally.

The solid-state image pickup apparatus of the invention contains a solid-state image pickup apparatus wherein the step of molding the flat board includes a step of placing the diaphragm formed as a separate member.

### Advantages of the Invention

According to the invention, there can be provided a solid-state image pickup apparatus for preventing a burr, powder dust, etc., causing a black point deterioration of video image from dropping off onto the light reception face and improving productivity and a manufacturing method of the solid-state image pickup apparatus.

### BRIEF DESCRIPTION OF THE DRAWINGS

FIG. 1A is an external perspective view of a solid-state image pickup apparatus according to a first embodiment; and FIG. 1B is a sectional view taken on line A-A in FIG. 1A.

FIG. 2A is a drawing to describe a structure molding step of the solid-state image pickup apparatus according to the first embodiment; FIG. 2B is a drawing to describe a lens (translucent member) placing step of the solid-state image pickup apparatus according to the first embodiment; and FIG. 2C is a drawing to describe a solid-state image pickup device placing step of the solid-state image pickup apparatus according to the first embodiment.

FIG. 3A is a drawing to describe a resin sealing step of the solid-state image pickup apparatus according to the first embodiment; FIG. 3B is a drawing to describe the resin sealing step of the solid-state image pickup apparatus according to the first embodiment; and FIG. 3C is a drawing to describe a use example of the solid-state image pickup apparatus according to the first embodiment.

FIG. 4A is an external perspective view of a solid-state image pickup apparatus in a related art; and FIG. 4B is a sectional view taken on line A-A in FIG. 5.

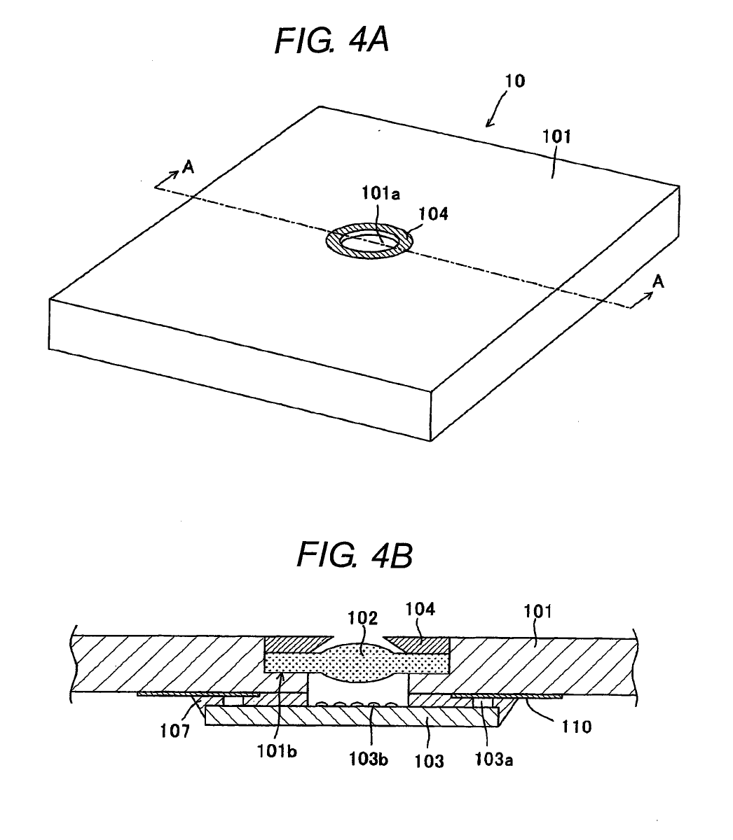

FIG. 5 is a drawing to describe an assembly process of the solid-state image pickup apparatus in the related art.

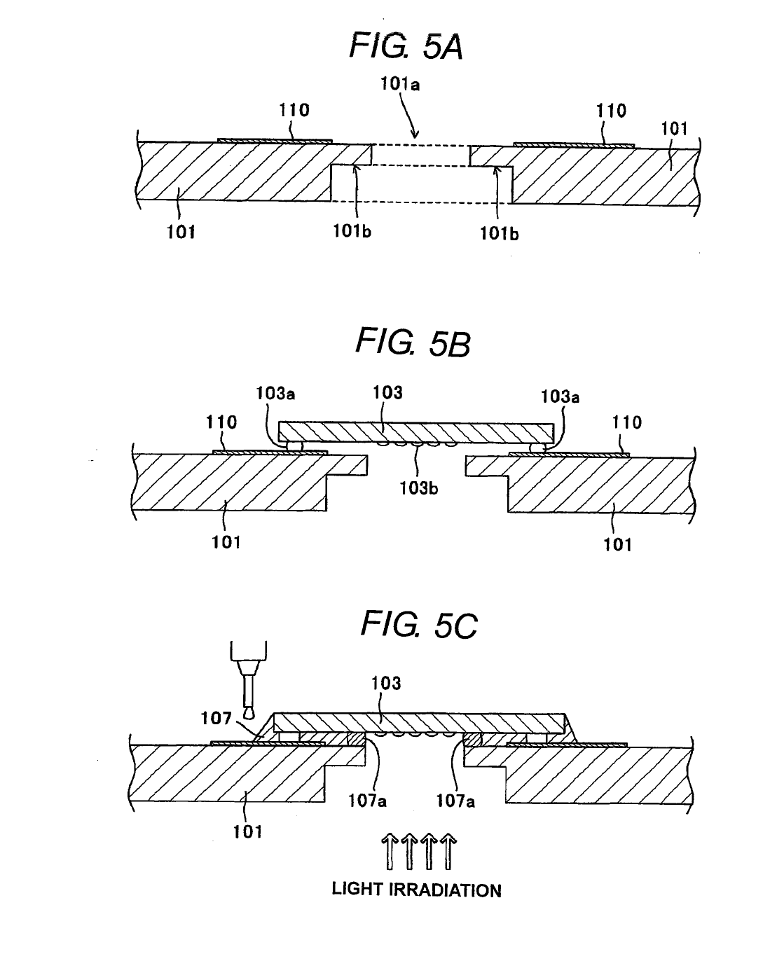

FIG. 6 is a drawing to describe the assembly process of the solid-state image pickup apparatus in the related art.

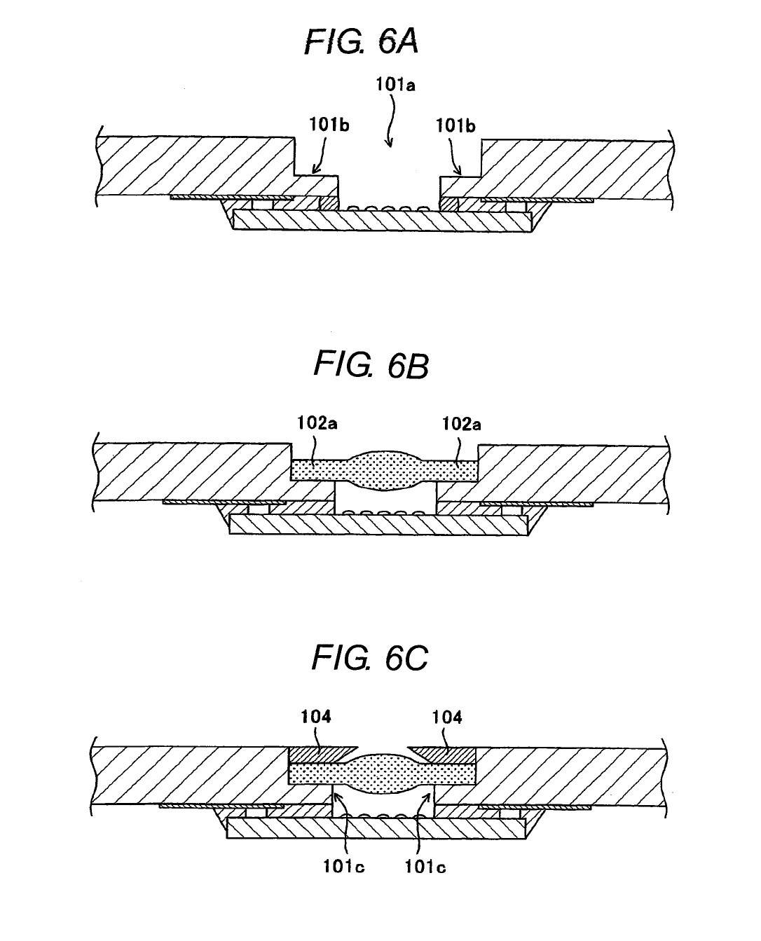

### DESCRIPTION OF REFERENCE NUMERALS

10 Solid-state image pickup apparatus

11 Printed board

11a Through opening

11b Step part

11c Wiring section

11d Diaphragm part

12 Lens

13 Solid-state image pickup device

13a Bump

13b Light reception face

14 Sealing resin

### BEST MODE FOR CARRYING OUT THE INVENTION

An embodiment according to the invention will be discussed in detail with reference to the accompanying drawings.

### First Embodiment

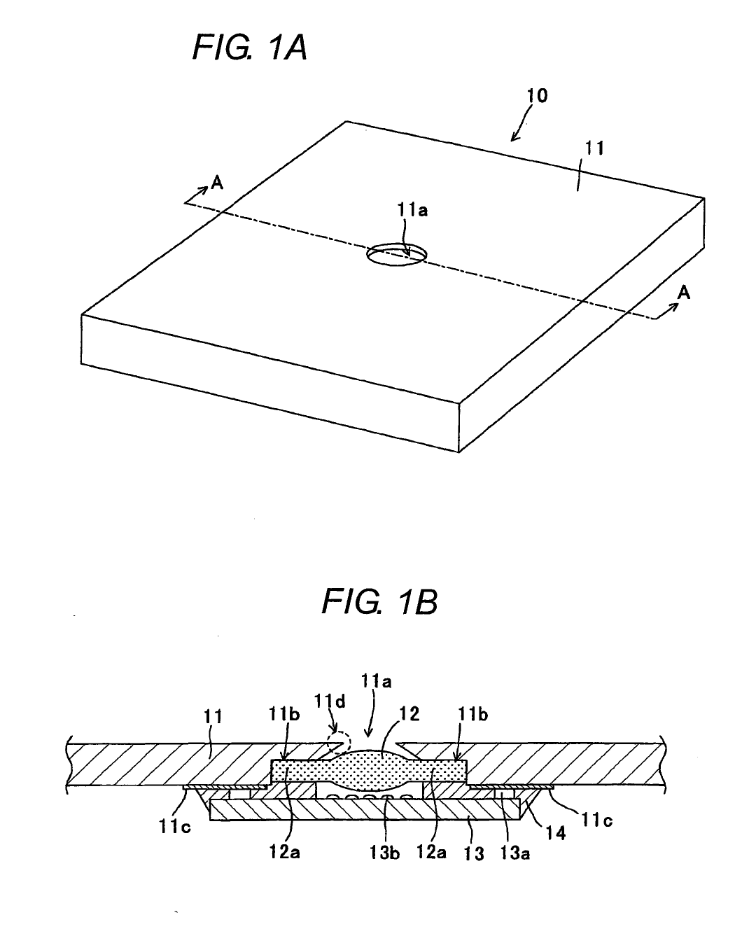

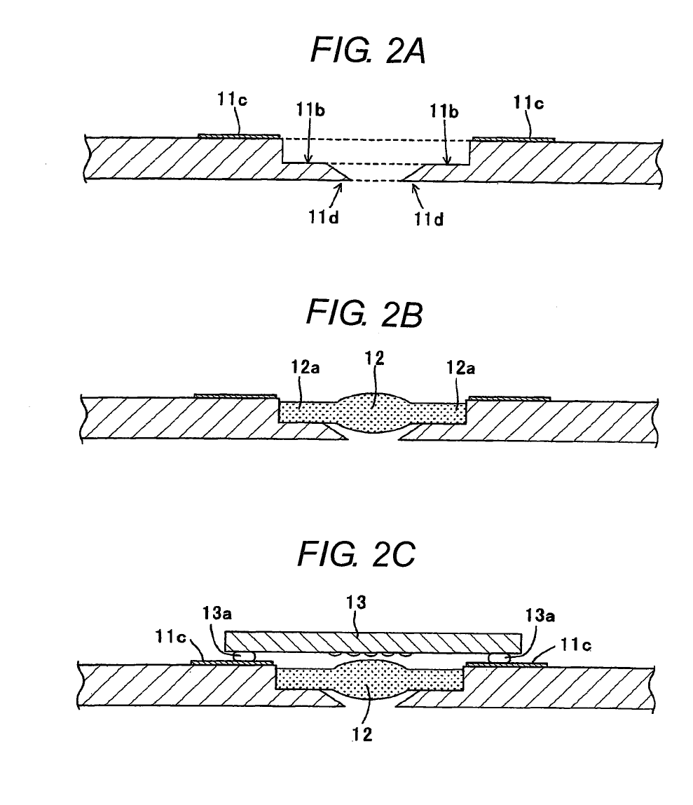

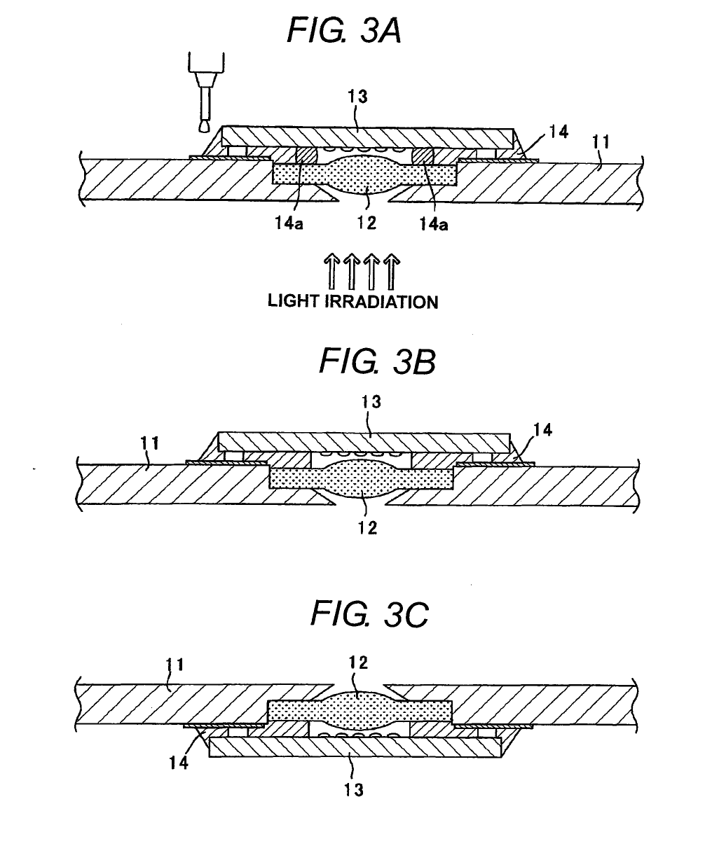

FIG. 1A is an external perspective view of a solid-state image pickup apparatus according to a first embodiment. FIG. 1B is a sectional view taken on line A-A in FIG. 1A. FIGS. 2 and 3 are drawings to describe an assembly process of the solid-state image pickup apparatus according to the first embodiment.

In the solid-state image pickup apparatus of the first embodiment, a solid-state image pickup device and a lens are placed on one side of a flat board (the side where a wiring section is formed) and are integrally sealed with resin unlike the mode in which a solid-state image pickup device and a translucent member such as a lens are placed so as to sandwich a board as in the related art, so that an inner wall of a through opening and the end part of the through opening on the light reception face side are covered with the outer peripheral edge of the lens and the sealing resin, and are not exposed to the light reception face of the solid-state image pickup device. Thus, a foreign material of a burr, powder dust, etc., causing a black point deterioration of a video image is prevented from dropping off onto the light reception face.

As shown in FIGS. 1A and 1B, a solid-state image pickup apparatus 10 of the first embodiment has a lens 12 as a translucent member and a solid-state image pickup device 13 placed on a flat printed board 11.

The flat-shaped printed board 11 is formed in the vicinity of the center with a circular through opening 11a piercing from one face of the board (hereinafter, a front side) to an opposite face (hereinafter, a back side). A wiring section 11c containing a terminal pattern for electrically connecting to other components is formed on the back surface of the board 11.

A step part 11b for placing the lens 12 thereon is formed on the back side of the through opening 11a where the wiring section 11c is formed. The step part 11b is formed in a size slightly wider than the outer shape of the lens 12 so that the lens 12 can be fitted. On the other hand, a diaphragm part 11d for adjusting the amount of light entering the lens 12 is formed on the front side of the through opening 11a. The diaphragm part lid is provided as it is integrally molded with the printed board 11.

For example, the lens 12 is a convex lens with the center thicker than an outer peripheral edge 12a for guiding light incident from the through opening 11a into a light reception face 13b of the solid-state image pickup device 13. The outer peripheral edge 12a of the lens 12 is placed on the step part 11b of the board 11.

The lens 12 is provided by forming a material having an infrared removal function like a convex lens shape and has a surface coated with an antireflection film by a coating method of vacuum evaporation, etc.

The solid-state image pickup device 13 is a photoelectric conversion element put into an integrated circuit using semiconductor manufacturing technology and is an arrangement of photodiodes for detecting light to generate charge and charge transfer parts for transferring detected charge. The solid-state image pickup device 13 is placed on a part of the wiring section 11c through a bump 13a for electric connection.

The lens 12 is placed so as to fill the through opening 11a as described above. The solid-state image pickup device 13 is placed so that the light reception face 13b is at a predetermined distance from the lens 12 to cover the lens 12. The lens 12 and the solid-state image pickup device 13 are integrally molded with a resin sealer 14. Thus, the light reception face 13a of the solid-state image pickup device 13 is placed in the seal space formed by the lens 12 and the resin sealer 13.

According to the configuration, in the solid-state image pickup apparatus 10 of the first embodiment, the light reception face 13b of the solid-state image pickup device 13 is not exposed to the inner wall surface of the through opening 11a, so that dust, a burr, etc., causing a black point deterioration of video image can be prevented from dropping off onto the light reception face.

Since the solid-state image pickup apparatus is formed using the flat board, the whole apparatus can be miniaturized and slimmed down as compared with the solid-state image pickup apparatus using the stereoscopic board in the related art. The lens is provided with the infrared cutting function, the antireflection function, etc., for omitting an optical filter, so that the number of components can be decreased. As the translucent member, a member is adopted to include a lens single unit, a filter single unit, an antireflection film, or a plurality of functions of a lens, a filter, an antireflection film, etc.

Next, a manufacturing method of the solid-state image pickup apparatus 10 will be discussed.

(Structure-Molding Step)

In this step, first a flat-shaped printed board 11 having a circular through opening 11a piercing from one face to an opposite face in the center is formed.

The material of the printed board 11 is glass fiber, epoxy resin, etc., for example. First, the printed board 11 is formed with the through opening 11a by machining, etc., and the through opening 11a is formed with a step part 11b and a diaphragm part 11d.

Next, a wiring section 11c is formed on the back surface of the board by a coating process or a thinning process of a sputtering method, etc., in a predetermined area of the printed board 11. The board 11 is placed in a state where the face provided with the wiring section 11c faces upward, as shown in FIG. 2A.

(Lens Placing Step)

In this step, the lens 12 is placed on the step part 11b so that the optical axis passes through the center of the lens 12, as shown in FIG. 2B. An outer peripheral edge 12a of the lens 12 is placed on the step part 11b. In this state, the lens 12 covers the through opening 11a.

(Solid-State Image Pickup Device Placing Step)

Subsequently, a solid-state image pickup device 13 is placed on the wiring section 11c of the board 11 so that the optical axis passes through the center of a light reception face 13b of the solid-state image pickup device 13, as shown in FIG. 2C. A connection electrode of the solid-state image pickup device 13 is formed with a bump 13a and the bump is connected to a predetermined position of the wiring section 11c by thermocompression bonding.

(Resin Sealing Step)

As shown in FIGS. 3A and 3B, a sealing resin 14 is injected into a gap of the solid-state image pickup device 13 and the printed board 11 while irradiating with light (FIG. 3A). At this time, the sealing resin 14 hardens in the range in which the irradiated light reaches the resin. Numeral 14a in FIG. 3C denotes a sealing resin harden part hardened by irradiation with light. Further, after this, the sealing resin 14 is thermally hardened and the lens 12 and the solid-state image pickup device 13 are integrally coated by the resin sealer 14 (FIG. 3B). The solid-state image pickup apparatus 10 of the first embodiment is thus manufactured.

The solid-state image pickup apparatus 10 of the first embodiment is inverted as required, for example, as shown in FIG. 3C and is built in an electronic machine, etc.

As described above, since the lens 12 and the solid-state image pickup device 13 are placed on the same face of the printed board 11, the manufacturing method of the solid-state image pickup apparatus 10 of the first embodiment can be conducted in sequence without the need for turning the printed board 11 upside down to place the respective members on the printed board 11. That is, the inverting or turning step can be omitted.

Further, the step of adhering the members are executed only once by resin sealing. Since the solid-state image pickup device and the translucent member such as the lens are placed on one face of the flat board, the diaphragm part can be formed on the opposite face. The diaphragm part is formed in the structure molding step, so that the later step of placing the diaphragm part can be omitted.

Thus, the manufacturing method of the solid-state image pickup apparatus 10 of the first embodiment makes it possible to omit the inverting or turning step and the step of fitting the diaphragm part in the related art and thus productivity improves as compared with the manufacturing method in the related art.

In the description given above, the diaphragm part lid is molded integrally with the printed board 11, but the embodiment is not limited to the mode and the printed board 11 and the diaphragm part lid may be formed as separate members. To form them as separate members, when the amount of light entering the light reception face 13b of the solid-state image pickup device 13 is changed, the design of the whole configuration of the printed board 11 need not to be changed and a diaphragm part for taking in the optimum light amount can be formed simply by changing the shape of the diaphragm member.

The solid-state image pickup apparatus described above is not limited to the optical communication field as a camera and can be applied to various optical devices such as a read device of a DVD, etc., a read device of a copier, a medical machine, or a door phone.

### INDUSTRIAL APPLICABILITY

The solid-state image pickup apparatus and its manufacturing method of the invention are useful as a solid-state image pickup apparatus for preventing a burr causing a black point deterioration of a video image from dropping off onto the light reception face and improving productivity and a manufacturing method of the solid-state image pickup apparatus.

1-11. (canceled)

12. A solid-state image pickup apparatus, comprising:
a flat board having a through opening, a step part provided in an opening end part of the through opening, and a wiring section provided on the same face as the step part;
a translucent member placed on the step part;
a solid-state image pickup device placed on the wiring section so that a light reception face of the solid-state image pickup device faces the translucent member; and
a sealing part which seals with a resin a placing area of the translucent member placed on the step part and the solid-state image pickup device, integrally.

13. The solid-state image pickup apparatus as claimed in claim 12,
wherein the through opening of the flat board includes a diaphragm part which is disposed in an end part on a second face, opposite to a first face that the light reception face of the solid-state image pickup device faces, and adjusts an amount of light entering the light reception face.

14. The solid-state image pickup apparatus as claimed in claim 13, wherein the diaphragm part is formed integrally with the flat board.

15. The solid-state image pickup apparatus as claimed in claim 13, wherein the diaphragm part is formed as a member separate from the flat board.

16. The solid-state image pickup apparatus as claimed in claim 12, wherein the translucent member is a lens having a light gathering function.

17. The solid-state image pickup apparatus as claimed in claim 12,
wherein the translucent member has an infrared cutting function.

18. The solid-state image pickup apparatus as claimed in claim 12,
wherein the translucent member has an antireflection function.

19. A manufacturing method of a solid-state image pickup apparatus, the method comprising:
a flat board molding step of molding a flat wiring board having a through opening, a step part provided in an opening end part of the through opening, and a wiring section provided on the same face as the step part;
a translucent member placing step of placing a translucent member on the step part;
a solid-state image pickup device placing step of placing a solid-state image pickup device on the wiring section; and
a resin sealing step of sealing with a resin the solid-state image pickup device placed on the wiring section and the placing area of the translucent member placed on the step part, integrally.

20. The manufacturing method of the solid-state image pickup apparatus as claimed in claim 19,
wherein the step of molding the flat board is a step of molding the flat board so that the through opening includes a diaphragm part which is disposed in an end part on a second face, opposite to a first face that the light reception face of the solid-state image pickup device faces, and adjusts an amount of light entering the light reception face.

21. The manufacturing method of the solid-state image pickup apparatus as claimed in claim 20,
wherein the step of molding the flat board includes a step of molding the diaphragm integrally.

22. The manufacturing method of the solid-state image pickup apparatus as claimed in claim 20,
wherein the step of molding the flat board includes a step of placing the diaphragm formed as a separate member.
